(19) United States
(12) Patent Application Publication
(10) Pub. No.: US 2010/0258194 A1
(43) Pub. Date: Oct. 14, 2010

(54) METHOD FOR CONTROLLING HEATING SYSTEM

(75) Inventor: Si-hwan Kim, Incheon (KR)

Correspondence Address: LEYDIG VOIT & MAYER, LTD, 700 THIRTEENTH ST. NW, SUITE 300, WASHINGTON, DC, 20005-3960, US

(73) Assignee: KYUNGDONG NETWORK CO., LTD., Seoul (KR)

(21) Appl. No.: 12/745,924

(22) PCT Filed: Nov. 18, 2008
(86) PCT No.: PCT/KR08/06790

§ 371 Date: Jun. 3, 2010

(30) Foreign Application Priority Data
Dec. 4, 2007 (KR) 2007-0124657

(51) Int. Cl. F15D 1/00

(52) U.S. Cl. 137/1

(57) ABSTRACT

A method for controlling a heating system for uniformly heating respective rooms by proportionally calculating heat supplies required by the respective rooms, even when the heat supplies required for heating the respective rooms are different from each other, depending on indoor temperature conditions and external conditions of the respective rooms. The method adjusts flow rates of heating water supplied to the respective rooms by adjusting opening rates of room valves installed in heating water pipes. Current temperature differences between temperatures set for the respective rooms and indoor temperatures measured in the respective rooms are calculated, and opening rates of other room valves of other rooms, excluding rooms having a current temperature difference larger than a previously set temperature difference, are reduced.

### TECHNICAL FIELD

The present invention relates to a method for controlling a heating system, and more particularly, to a method for controlling a heating system capable of adjusting a flow rate of heating water depending on heating requirements of the respective rooms to evenly heat the respective rooms.

### BACKGROUND ART

Generally, a boiler system includes a warm water distributor for distributing heating water to the respective rooms to be heated. The warm water distributor receives water heated by a heat exchanger of a boiler through a heating water supply pipe to supply the heated water to the respective rooms. The supplied water transmits heat energy to the respective rooms and then is cooled, and conveyed to a water return pipe. The warm water distributor includes room valves for adjusting a flow rate of heating water supplied into the respective rooms.

The room valves are classified into three types depending on control methods: an ON/OFF type, a constant flow rate type, and a proportional control type.

FIG. 1 is a schematic view of a heating system including ON/OFF valves and constant flow rate valves.

The ON/OFF valves 21 are installed at a distributor 20, where heating water supplied from a heat source 10 is distributed into the respective rooms 30, to block the valves 21 to stop supply of the heating water when a room temperature arrives at a temperature set by a user, and to open the valves 21 to supply the heating water when the room temperature is lower than the temperature set by a user.

The constant flow rate valves 41 are installed at a distributor 40, where heating water is returned, to prevent the heating water from flowing therethrough at more than a set flow rate. When heating water from a single heat source 10 is supplied into a plurality of rooms 30, different piping lengths of the respective rooms 30 cause arrival times at the set temperatures of the respective rooms 30 to vary. Therefore, in order to solve problems of irregular heating conditions, the constant flow/rate valves 41 are installed at the respective pipes connected to the respective rooms 30 to uniformize the arrival times at the set temperatures of the respective rooms 30.

The constant flow rate valves 41 have advantages of reducing the entire length of the heating pipes, reducing the number of distributors, and solving problems related to irregular heating, and thus, have been used for various heating systems.

However, since the flow rates of the constant flow rate valves 41 are set by a construction company upon construction depending on the length and diameter of the constant flow rate valves 41, it is impossible for a user to arbitrarily vary a flow rate of the valves 21 once set by the company. Therefore, when the length of the heating pipes is varied by remodeling, such as extension of a balcony, etc., heating irregularity may occur again.

In addition, heat supplies required by the respective rooms 30 are determined by positions of the respective rooms 30 (whether the rooms 30 have a good supply of sunlight), insulation of the respective rooms 30, external conditions such as an external temperature, and so on, in addition to the length of the pipes. As a result, heat supplies required for the respective rooms 30 to uniformly heat the rooms 30 may be different from each other. However, since the constant flow rate valves 41 are manually adjusted, it is impossible to adjust the flow rate of the valves 41 depending on actual states of the rooms 30.

Therefore, in order to solve the problems of the constant flow rate valve 41, a proportional control valve has been developed.

FIG. 2 is a schematic view of a heating system having proportional control valves.

The proportional control valves 42 are installed at a distributor 40a, where heating water supplied from a heat source 10 is returned after passing through the respective rooms 30, to adjust a flow rate of heating water to provide a comfortable indoor environment according to the set temperature of each respective room. Reference numeral 20a is a distributor in which heating water is supplied.

The conventional proportional control valve receives flow rate data fed back from a flow sensor to adjust an opening rate of the valve to adjust a supply amount of the heating water. However, since there are many foreign substances in the heating water, the flow sensor may be contaminated.

In addition, when the flow sensor is not used, as shown in FIG. 2, a proportional-in-tegrated-derivative (PID) control method is used. In the PID control method, temperature sensors 43 measure a temperature of returned heating water, and the measured temperature of the returned water is fed back to the temperature sensors 43. The temperature sensors 43 calculate deviation between a target temperature and the current temperature to provide a control amount in proportion to the deviation until the temperature arrives at the target temperature. That is, the PID control method includes calculating the deviation between the target temperature and the current temperature, adjusting an opening rate of the valves 42 in proportion to the deviation, and measuring variation in the temperature of the returned water to re-adjust the opening rate of the valve, wherein a flow rate of the valves 42 is adjusted through repeated adjustments of the opening rate of the valves 42 until the temperature arrives at the target temperature.

Since the temperature of the returned heating water is a temperature after passing through the pipes installed in the respective rooms, the temperature becomes the best information for determining heat supplies required by the respective rooms 30. However, response characteristics are too slow to uniformly control heating of the respective rooms 30.

That is, when the flow rate is adjusted by adjusting an opening rate of the proportional control valve 42, the adjusted flow rate affects the temperature of the returned heating water, which is time consuming, and thus, it is impossible to instantly determine whether the adjusted flow rate is appropriate. In addition, since the rooms 30 are independently controlled by the valves 42, respectively, variation in flow rate of one room affects another room, and thus, it is substantially impossible to organically control the flow rate of the respective rooms 30 due to the slow response characteristics.

Therefore, the conventional proportional control method cannot uniformly control heating of the respective rooms 30.

### DISCLOSURE

### Technical Problem

In order to solve the foregoing and/or other problems, it is an aspect of the present invention to provide a method for controlling a heating system capable of uniformly heating respective rooms by proportionally calculating heat supplies required by the respective rooms, even when the heat supplies required for heating the respective rooms are different from each other due to indoor temperature conditions and external conditions of the respective rooms.

### Technical Solution

One aspect of the present invention provides a method for controlling a heating system that adjusts flow rates of heating water supplied into the respective rooms by adjusting opening rates of a plurality of room valves installed on heating water pipes, characterized in that current temperature differences between temperatures set for the respective rooms and indoor temperatures measured in the respective rooms are calculated, and opening rates of the room valves of the other rooms, except rooms having the current temperature difference larger than a previously set temperature difference, are reduced.

A down ratio of the opening rates of the other room valves may be in proportion to the current temperature difference of the rooms having the current temperature difference larger than the previously set temperature difference.

The down ratio of the opening rates of the other room valves may be in proportion to the number of the rooms having the current temperature difference larger than the previously set temperature difference.

When the number of the rooms having the current temperature difference larger than the previously set temperature difference is plural and the measured temperature differences of the rooms are different from each other, the down ratio of the opening rates of the room valves installed at the other rooms may be in proportion to an average of the plurality of measured current temperature differences.

When a second set temperature difference smaller than the set temperature difference is previously set and the current temperature differences of the room having the current temperature difference larger than the previously set temperature difference is smaller than the second set temperature difference after the opening rates of the room valves installed at the other rooms are reduced, the opening rates of the room valves of the other rooms may be returned to their states before reduction.

The reduction of the opening rates of the respective room valves may be performed after measuring temperatures of the returned heating water, calculating a ratio of the opening rates of the respective room valves depending on a ratio of arrival times of the measured returned water temperatures to the previously set temperatures, and setting an opening rate of the room valve having the latest arrival time as a maximum opening rate such that the opening rates of the other room valves are proportionally set with respect to the maximum opening rate to be reduced as the arrival time becomes shorter to primarily adjust the opening rates of the room valves depending on the set ratio of the opening rates.

### ADVANTAGEOUS EFFECTS

In accordance with a method of controlling a heating system in accordance with the present invention, heat supplies required for heating the respective rooms are determined to adjust flow rates supplied into the respective rooms, thereby uniformly heating the respective rooms to provide comfortable indoor environments.

In addition, primarily adjusting a valve opening rate depending on a temperature of the returned water and then secondarily adjusting the valve opening rate in consideration of a difference between the current indoor temperature and the set temperature of each room, it is possible to prevent delay of an arrival time at the set temperature due to a difference between heat supplies required by the respective rooms and supplied heat limited by the primary valve opening rates when there is a difference between the current indoor temperature and the set temperature of the respective rooms.

### DESCRIPTION OF DRAWINGS

The above and other objects, features and advantages of the present invention will be more apparent from the following detailed description taken in conjunction with the accompanying drawings, in which:

FIG. 1 is a schematic view of a heating system including an ON/OFF valve and a constant flow rate valve;

FIG. 2 is a schematic view of a heating system including proportional control valves;

FIG. 3 is a block diagram of a heating system employing a control method in accordance with the present invention;

FIG. 4 is a cross-sectional view of each of room valves adapted to a heating system in accordance with an exemplary embodiment of the present invention;

FIG. 5 is a schematic view of a linear magnet adapted to FIG. 4;

FIG. 6 is a flowchart of a method for controlling a heating system in accordance with an exemplary embodiment of the present invention;

FIG. 7 is a graph showing arrival times at set temperatures of returned water of the respective rooms; and

FIG. 8 is a flowchart showing the case in which a valve opening angle adjustment process depending on a temperature of returned water is previously performed before performing the valve opening angle adjustment process shown in FIG. 6.

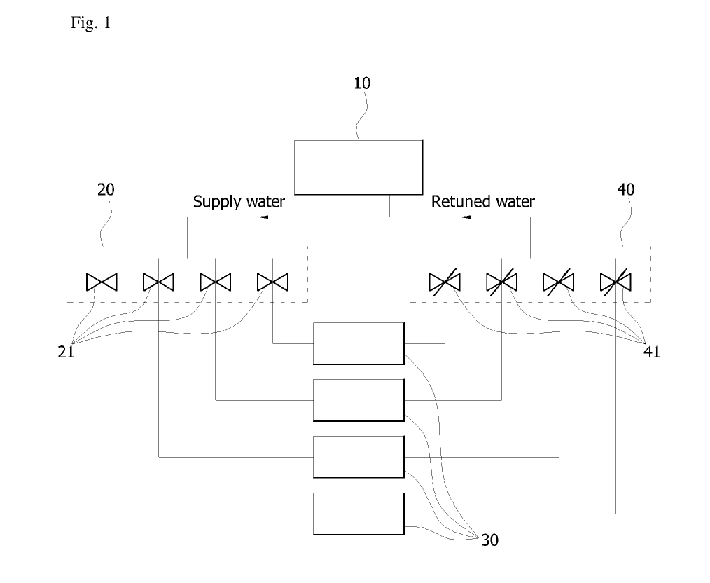

### MODES OF THE INVENTION

Exemplary embodiments of the present invention will now be described in detail with reference to the accompanying drawings.

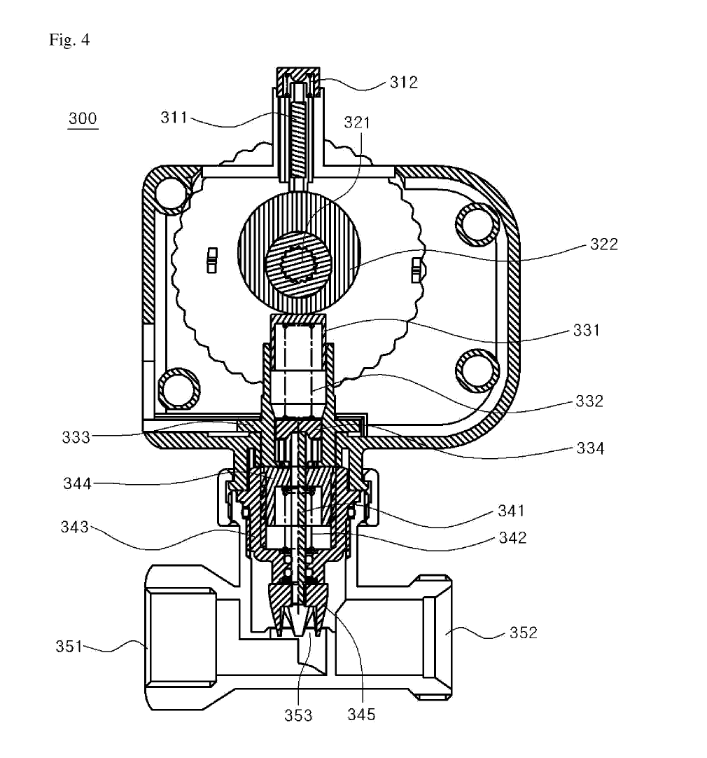

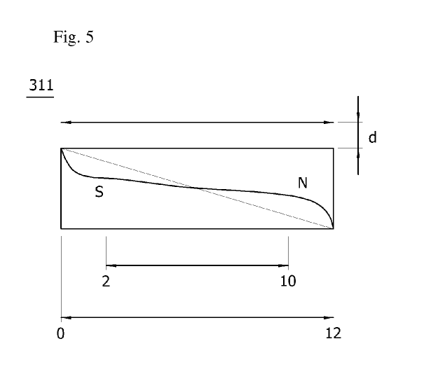

FIG. 3 is a block diagram of a heating system employing a control method in accordance with the present invention, FIG. 4 is a cross-sectional view of each of room valves adapted to a heating system in accordance with an exemplary embodiment of the present invention, and FIG. 5 is a schematic view of a linear magnet adapted to FIG. 4.

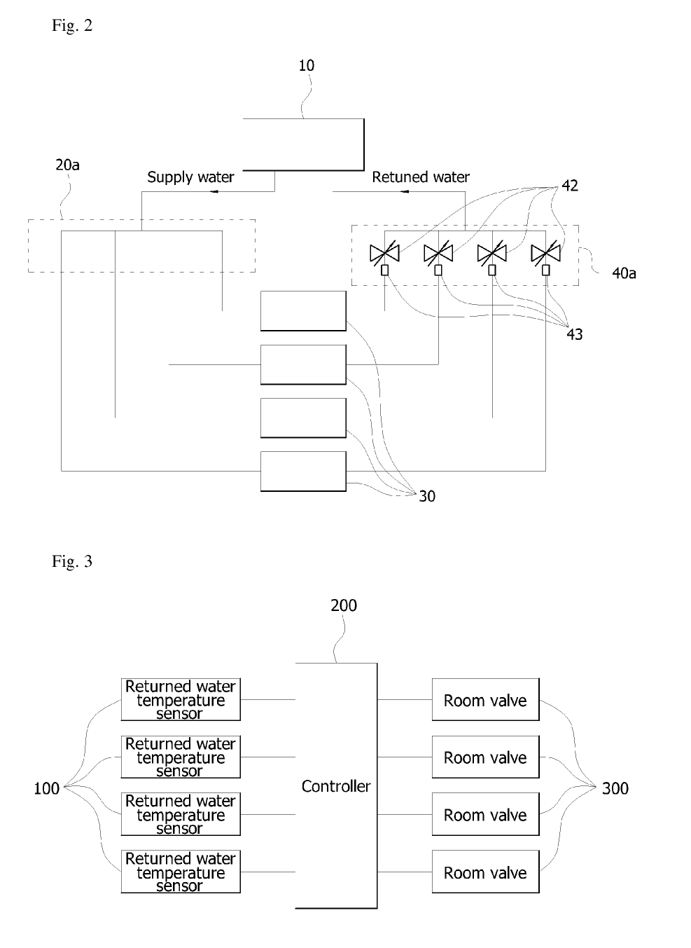

Basic constitution of the heating system in accordance with the present invention is similar to that of FIG. 2. That is, as shown in FIG. 3, the heating system includes indoor temperature sensors 100 for detecting indoor temperatures, the respective room valves 300 installed at heating pipes through which the returned water passes to adjust a flow rate of the heating water, and a controller 200 for receiving temperature data detected by the returned water temperature sensors 100 to adjust opening rates of the respective room valves 300.

An example of the room valve 300 adapted to the present invention will be described with reference to FIG. 4.

The room valve 300 includes a motor (not shown) rotated by alternate current in one direction, a cam member 322 eccentrically connected to a shaft 321 of the motor, and a valve part 345 reciprocated along a profile of an outer periphery of the cam member 322 to adjust an opening rate of a heating water flow path when the motor shaft 321 is rotated.

A cam contact member 331 is resiliently supported at a lower surface of the cam member 322 by a spring 332. The cam contact member 331 is inserted into an upper guide member 333 to be guided by the upper guide member 333 upon vertical movement thereof. A shaft contact member 334 is inserted into an inner lower part of the upper guide member 333. A lower end of the spring 332 is in contact with an upper surface of the shaft contact member 334, and a center of a concaved lower surface of the shaft contact member 334 is in contact with an upper end of a shaft 341.

The shaft 341 passes through a center of a rotary lock member 344 coupled to an inside of a lower guide member 343, and has a lower end coupled to a valve part 345. A spring 342 is fitted onto an outside of the shaft 341 to be pressed upon lowering of the shaft 341. The valve part 345 opens and closes an opening 353 formed between an inlet 351 and an outlet 352 of a heating water flow path, and a vertical position thereof is varied with the shaft 341.

Meanwhile, a linear magnet 311 is installed to be resiliently supported by the spring 312 and to be always in contact with an outer surface of the cam member 322 upon rotation of the cam member 322, and a vertical position of the linear magnet 311 is varied along a cam profile of the cam member 322. A magnetic sensor (not shown) and a printed circuit board (not shown) are installed at a position adjacent to the linear magnet 311 to detect magnetic flux varied upon variation in position of the linear magnet 311 to control rotation of the motor.

Here, the “linear magnet” means a magnet that exhibits straightness (linearity) of variation in magnetic flux depending on displacement. Hereinafter, the linear magnet 311 and the magnetic sensor will be described.

The linear magnet 311 shown in FIG. 5 is disclosed in Korean Patent Registration No. 660564.

Referring to FIG. 5, an N polarity and an S polarity are magnetized at the linear magnet 311 from a left upper corner of a rectangular shape in a diagonal direction in a sine-wave form.

In general, it is known that magnetic flux is in reverse proportion to a square distance. Therefore, in the case of a general magnet, variation in magnitude of a magnet depending on displacement has no linearity of a secondary function graph.

On the other hand, as shown in FIG. 5, in the linear magnet 311 adapted to the present invention, while there is no linearity of magnetic flux of the N polarity depending on displacement when the magnet is magnetized in a diagonal direction as shown in a dotted line, the magnetic flux depending on the displacement represents linearity when the magnet is magnetized in a sine-wave form in a diagonal direction as shown in a solid line.

The magnetic sensor for detecting variation in magnetic flux depending on variation in position of the linear magnet 311 of FIG. 5 detects the variation in magnetic flux over sections 0 to 12 of the magnet 311. A polar surface of the linear magnet 311 is spaced apart a predetermined distance d from the magnetic sensor and the linear magnet 311 moves in a direction perpendicular to a polar axis and parallel to the polar surface. In this case, among the sections 1 to 12, all but the outermost non-linear sections, i.e., sections 2 to 10, may be employed as use sections.

The magnetic sensor used to measure variation in magnetic flux depending on position variation of the linear magnet 311 may be a hall sensor (programmable hall IC) widely used as a method of detecting a magnetic field. Operation of the hall sensor generates electric potential perpendicular to a current direction and a magnetic field direction when current is flowed to an electrode of a semiconductor (hall device) to apply a magnetic flux, and thus, it is possible to detect variation in position of the linear magnet 311 from the electric potential.

While the method using the linear magnet as a non-contact type has been described, the method using a variable resistor and a variable inductance, instead of the linear magnet and the magnetic sensor, may be provided.

When the variable resistor is used, an output voltage of the variable resistor depending on an opening rate of the valve part is preset, and when a contact position of the variable resistor is varied depending upon rotation of the motor, it is possible to detect the opening rate on the basis of the output voltage depending on the variation.

In addition, when the variable inductance is used, an output voltage of the variable inductance depending on an opening rate of the valve part is preset, and when a position of the magnet in a coil is varied depending on rotation of the motor, it is possible to detect the opening rate of the valve part from the output voltage depending on the variation.

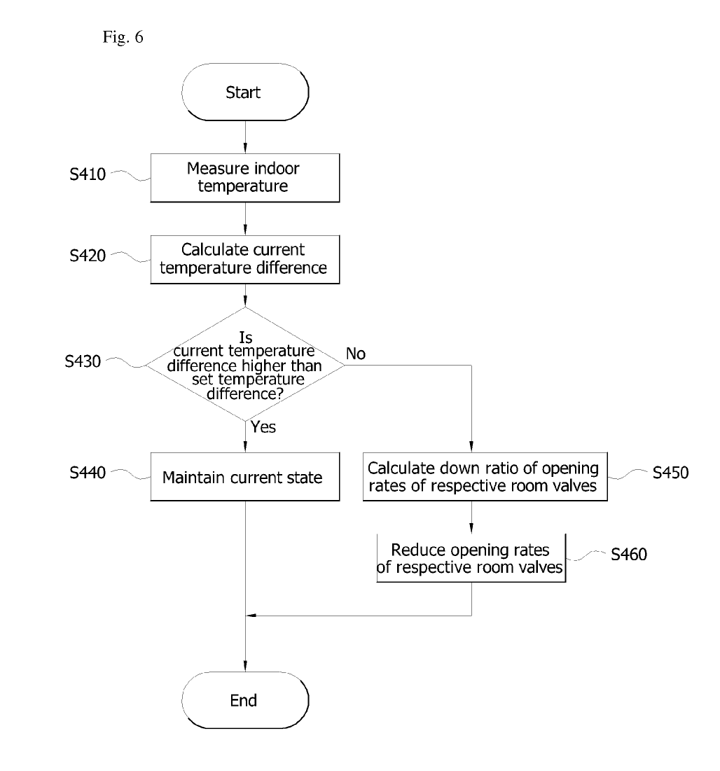

Hereinafter, a control method in accordance with an exemplary embodiment of the present invention will be described with reference to FIG. 6.

FIG. 6 is a flowchart of a method for controlling a heating system in accordance with an exemplary embodiment of the present invention.

Indoor temperature sensors 100 installed in the respective rooms measure indoor temperatures of the respective rooms (S410). In addition, set temperatures of the respective rooms, i.e., temperatures required for heating the rooms are set by a user.

When the indoor temperatures of the respective rooms are measured and transmitted to a controller 200, the controller 200 calculates the current temperature difference between the set temperatures set by the respective rooms and indoor temperature measured in the respective rooms (S420).

TABLE 1

| | First | | | |
|---|---|---|---|---|
| Classification | Room | Second Room | Living Room | Third Room |
| Current Indoor | 22 | 21 | 19 | 21 |
| Temperature | | | | |
| Set | 23 | 26 | 18 | 21 |
| Temperature | | | | |
| Current | 1 | 5 | 1 | 0 |
| Temperature | | | | |
| Difference | | | | |

That is, in Table 1, the first room and the living room have a difference between the current indoor temperature and the set temperature of 1 C, the third room has no difference, and the second room has a temperature difference of 5 C. This means that the second room has the indoor temperature lower than the temperature desired by a user (set temperature), thus needing a larger supply of heat in comparison with the other rooms.

Therefore, in this case, it is required to adjust opening rates of the room valves to supply a larger amount of heating water into the second room.

Hereinafter, method of adjusting opening rates of room valves 300 will be described.

As described above, in preparation for the case in which the current temperature difference of a room becomes larger, the controller 200 has a set temperature difference, which is predetermined. Here, the set temperature difference is used as a reference for adjusting opening rates of the other rooms, except the rooms having the current temperature difference larger than or equal to the set temperature difference.

Hereinafter, the case in which the set temperature difference is 5° C. will be described.

In Table 1, the second room has the current temperature difference of 5° C. equal to the set temperature difference of 5° C. Therefore, the second room maintains the current opening rate of the room valve as it is (S440).

Opening rates of the room valves 300 of the other rooms, i.e., the first room, the living room, and the third room, but not the second room, are reduced to decrease a supplied amount of heating water to uniformly heat the rooms. In this case, a reduction ratio of the opening rates of the valves is calculated by the following formulae.

FDR (%)=(0.2ND+0.8)×DR(ND≧1) (1)

DR (%)=2ΔT(5≦ΔT≦10) (2)

Here, FDR (final down ratio) means a final valve opening rate reduction ratio, ND (number of difference) means the number of rooms having the current temperature difference of 5° C. or more, DR (down ratio) means a valve opening rate reduction ratio, and ΔT means the current temperature difference of the room having the current temperature difference of 5° C. or more.

In the above formulae, FDR is in proportion to the current temperature difference, and the number of the rooms having the current temperature difference of 5° C. or more.

The amount of heat supplied from a heat source is constant. Therefore, it will be appreciated that the more the current temperature difference increases and the more the number of rooms having the current temperature difference of 5° C. or more increases, the more the FDR should be increased in order to uniformly heat the rooms. In this example, since the second room requires a large amount of heat, the amount of heat supplied to the first room, the living room and the third room should be reduced.

Calculating FDR of Table 1 on the basis of the formulae, since the number of rooms having the current temperature difference of 5° C. or more is one (the second room) and the second room has the current temperature difference of 5° C., from the formula (2), DR (down ratio) is 10%, and from the formula (1), FDR (final down ratio) is 10% (S450).

When FDR of the room valves are calculated, the valve opening rates of the other rooms, except the second room, are reduced by 10% to adjust the valve opening rates on the basis of the calculated values (S460).

In a state in which the opening rates of the room valves are set as described above, the respective rooms are heated depending on temperatures set by a user through a room controller. When the room temperature exceeds the temperature set by the user, the room valve 300 is closed to stop heating, and when the temperature is lower than the temperature set by the user, the room valve 300 is opened to the set opening rate to heat the room in a repeated manner.

Hereinafter, the case having temperature relationship different from Table 1 will be described.

TABLE 2

| | First | | | |
|---|---|---|---|---|
| Classification | Room | Second Room | Living Room | Third Room |
| Current Indoor | 22 | 19 | 22 | 18 |
| Temperature | | | | |
| Set | 23 | 25 | 22 | 25 |
| Temperature | | | | |
| Current | 1 | 6 | 0 | 7 |
| Temperature | | | | |
| Difference | | | | |

Calculating FDR from Table 2, since the number of rooms having the current temperature difference of 5° C. or more is two (the second and third rooms) and the current temperature differences of the second and third rooms are 6° C. and 7° C., DRs (down ratios) from the formula (2) are 12% and 14%. In this case, the DR values are averaged as DRavr of 13%. When DRavr is substituted to the formula (1), FDR (final down ratio) is 15.6%.

When FDR of the respective rooms are calculated, the valve opening rates of the first room and the living room, but not the second and third rooms, are reduced by 15.6% to adjust the valve opening rates, respectively.

As described with reference to Tables 1 and 2, after the valve opening rates are varied depending on temperature differences of the respective rooms, when the current temperature differences of the second and third rooms is lower than a second set temperature difference, it is determined that the irregular heating problem is solved, and the valve opening rates of the other rooms are adjusted to return to a state before reduction.

Here, the second set temperature difference may be set to be lower than the above-mentioned set temperature (5° C.), for example, 2° C.

As described above, in a state in which the opening rates of the respective room valves 300 are set, the rooms are heated according to temperatures set by a user through a room controller. When the room temperature exceeds the temperature set by the user, the room valve 300 is closed to stop heating, and when the room temperature is lower than the temperature set by the user, the room valve 300 is opened by the opening rate set as above to heat the room in a repeated manner.

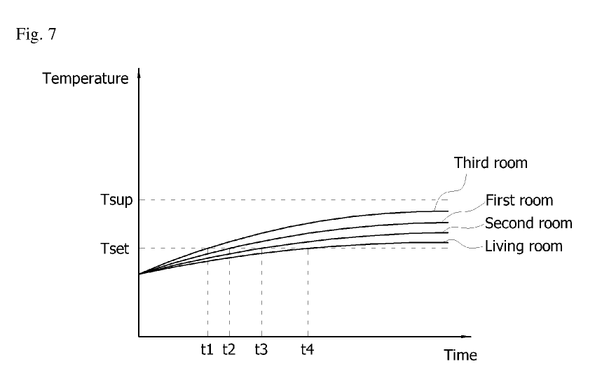

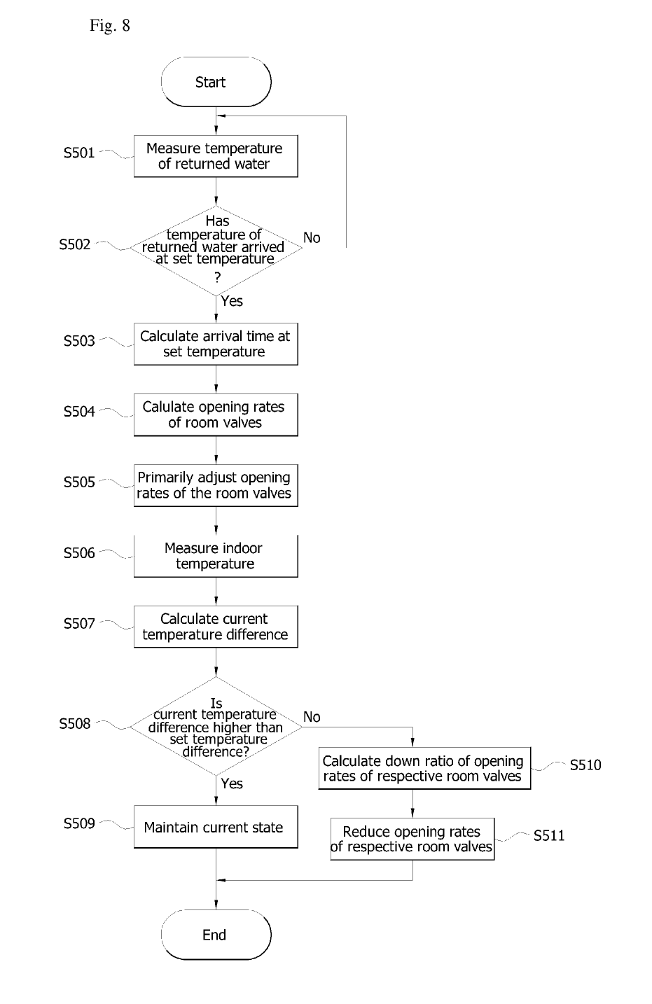

Hereinafter, a method for controlling a heating system in accordance with another exemplary embodiment of the present invention will be described with reference to FIGS. 7 and 8.

FIG. 7 is a graph showing arrival times at set temperatures of returned water of the respective rooms, and FIG. 8 is a flowchart showing the case in which a valve opening rate adjustment process depending on a temperature of returned water is previously performed before performing the valve opening rate adjustment process shown in FIG. 6.

In order to uniformly heating the respective rooms, various conditions should be considered. That is, heat supplies required by the respective rooms are different from each other depending on supply of sunlight, insulation, and so on. In addition, the temperature of the returned water is measured after the heating water passes through the respective rooms and then heat thereof is radiated. Therefore, the temperature of the returned water is an important reference that can determine heat supplies required by the respective rooms.

While a method of considering a difference between indoor temperatures of the rooms may be proposed, it is more preferable to adjust opening rates of the respective room valves in consideration of a temperature of the returned water, which most appropriately reflects the amounts of heat supplied to the respective rooms.

In this embodiment, returned water temperature sensors (not shown) are installed on the heating pipes to measure a temperature of the returned water.

First, when heating is started, the returned water temperature sensor measures a temperature of the returned water (S501).

When the temperature of the returned water is measured, it is determined whether the temperature of the returned water arrives at a predetermined set temperature Tset (S502). Here, the set temperature Tset is an arbitrary value, which may be set as an appropriate temperature lower than a temperature of supplied water Tsup.

Then, an arrival time at the set temperature Tset of the returned water temperature is calculated (S503). For example, as shown in the graph of set temperature arrival times of FIG. 7, an arrival time at the set temperature Tset of a third room is the fastest time t1, an arrival time at the set temperature Tset of a first room is t2, an arrival time at the set temperature Tset of a second room is t3, and an arrival time at the set temperature Tset of a living room is the latest time t4.

When the arrival times at the set temperature of the returned water temperature are calculated, a ratio of opening rates of the respective room valves 300 is calculated (S504).

The above process will be descried with reference to the following table.

| | First | | | |
|---|---|---|---|---|
| Classification | Room | Second Room | Living Room | Third Room |
| Arrival Time at | 8 | 10 minutes | 24 minutes | 6 minutes |
| Set Temperature | minutes | | | |
| Ratio | 33% | 42% | 100% | 25% |

That is, calculating ratios of arrival times of the respective rooms with reference to the arrival time (24 minutes as 100%) at the set temperature Tset of the living room, which is the latest time among the measured temperatures of the returned water, the ratios as described above are calculated.

This means that the living room requires the largest heat supply, and the faster the arrival time at the set temperature, the smaller the heat supply required for heating the room.

Therefore, a ratio of the arrival times at the set temperatures from the measured temperatures of the returned water is calculated. Since the calculated ratio of the arrival times at the set temperatures means a ratio of heat supplies required by the respective rooms, the ratio may be defined as a ratio of opening rates of the respective room valves 300.

Ultimately, as described in the above table, the room valve 300 installed at a heating pipe of the living room is fully opened (100%), the room valve 300 of the first room is opened by 33%, the room valve 300 of the second room is opened by 42%, and the room valve 300 of the third room is opened by 25% (S505).

When the opening rates of the respective rooms 300 are adjusted through the above method, the amounts of heat required for heating the rooms are determined and distributed to uniformly heat the respective rooms.

However, even though the opening rates of the respective room valves are primarily adjusted, when a temperature difference between the current room temperature and the temperature set by the user through the room controller is large, a difference between the amount of heat required by the respective rooms and the supplied heat limited by primary adjustment of a valve opening rate is generated. In this case, an arrival time at the set temperature may be somewhat delayed, causing irregular heating of the rooms.

Therefore, in this case, secondary adjustment of the valve opening rate is performed by the control method of FIG. 6 to solve problems of irregular heating.

Hereinafter, a process of adjusting an opening rate of the respective room valves will be described.

When the opening rates of the respective room valves 300 are set, the controller 200 rotates the motors of the respective room valves 300.

The controller 200 has a program in which correlation between variation in opening rates of the respective room valves and detected voltages is preset.

That is, when the valve part 345 is maximally opened, a voltage at a position of the linear magnet 311 is set as, for example, 4.5V, and when the valve part 345 is entirely closed, a voltage at a position of the linear magnet 311 is set as, for example, 0.5V, wherein values therebetween are represented as a straight section due to linearity of the linear magnet 311 (i.e., a proportional relationship is provided).

Therefore, the controller 200 sets a target voltage of the opening rates of the valve part 345 from the proportional relationship, and rotates the motor to move the valve part 345 to thereby adjust the opening rate.

In this case, since the cam member 322 is rotated with the motor, the linear magnet 311 is raised along a profile of an outer periphery of the cam member 322. When electric potential generated from the magnetic sensor depending on variation in position of the linear magnet arrives at the target voltage, the controller determines that the opening rate arrives at the target opening rate, and stops operation of the motor.

Therefore, the controller can set opening rates of the respective room valves 300 to uniformly heat the rooms in consideration of pipe lengths of the rooms and external conditions affecting temperature requirements of the rooms (the supply of sunlight, insulation, external temperatures, and so on) and differences between the set temperatures and the indoor temperatures of the respective rooms.

As described above, in a state in which the opening rates of the respective room valves 300 are set, a user can adjust a room controller to heat the rooms depending on temperatures set by the room controller. That is, when a room temperature exceeds the temperature set by the user, the room valve 300 is closed to stop the heating, and when the temperature is lower than the temperature set by the user, the room valve 300 is opened by the opening rate corresponding to the ratio set as described above to repeat the heating process.

### INDUSTRIAL APPLICABILITY

As can be seen from the foregoing, a method for controlling a heating system in accordance with the present invention enables uniform heating of rooms even when heat supplies required by the rooms are different from each other.

1. A method for controlling a heating system that adjusts flow rates of heating water supplied to respective rooms by adjusting opening rates of a plurality of room valves installed in heating water pipes, the method comprising:
calculating current temperature differences between temperatures set for the respective rooms and indoor temperatures measured in the respective rooms, and
reducing opening rates of other room valves of other rooms, excluding rooms having current temperature differences larger than a first previously set temperature difference.

2. The method according to claim 1, including determining a final down ratio of the opening rates of the other room valves in proportion to the current temperature differences of the rooms having current temperature differences larger than the first previously set temperature difference.

3. The method according to claim 2, including determining the final down ratio of the opening rates of the other room valves in proportion to the number of the rooms having current temperature differences larger than the first previously set temperature difference.

4. The method according to claim 2, wherein, when the number of the rooms having current temperature differences larger than the first previously set temperature difference is plural, and the measured temperature differences of the rooms are different from each other, determining the final down ratio of the opening rates of the other room valves in proportion to an average of the plurality of the measured current temperature differences.

5. The method according to claim 1, wherein, when a second previously set temperature difference, smaller than the first previously set temperature difference, and the current temperature differences of the rooms having a current temperature difference larger than a set temperature difference is smaller than the second previously set temperature difference, after the opening rates of the other room valves are reduced, returning the opening rates of the other room valves to their states before the reducing.

6. The method according to claim 1 including
reducing the opening rates of the respective room valves after measuring temperatures of returned heating water,
calculating a ratio of the opening rates of the respective room valves depending on a ratio of arrival times of the measured returned temperatures of the water to previously set temperatures, and
setting an opening rate of the room valve having the latest arrival time as a maximum opening rate such that the opening rates of the other room valves are proportionally set with respect to the maximum opening rate, for reduction, as the arrival time becomes shorter, to adjust the opening rates of the room valves depending on the ratio of the opening rates.

7. The method according to claim 2, wherein, when a second previously set temperature difference, smaller than the first previously set temperature difference, and the current temperature differences of the rooms having a current temperature difference larger than a set temperature difference is smaller than the second previously set temperature difference, after the opening rates of the other room valves are reduced, returning the opening rates of the other room valves to their states before the reducing.

8. The method according to claim 3, wherein, when a second previously set temperature difference, smaller than the first previously set temperature difference, and the current temperature differences of the rooms having a current temperature difference larger than a set temperature difference is smaller than the second previously set temperature difference, after the opening rates of the other room valves are reduced, returning the opening rates of the other room valves to their states before the reducing.

9. The method according to claim 4, wherein, when a second previously set temperature difference, smaller than the first previously set temperature difference, and the current temperature differences of the rooms having a current temperature difference larger than a set temperature difference is smaller than the second previously set temperature difference, after the opening rates of the other room valves are reduced, returning the opening rates of the other room valves to their states before the reducing.

10. The method according to claim 2, including
reducing the opening rates of the respective room valves after measuring temperatures of returned heating water,
calculating a ratio of the opening rates of the respective room valves depending on a ratio of arrival times of the measured temperatures of the returned water to previously set temperatures, and
setting an opening rate of the room valve having the latest arrival time as a maximum opening rate such that the opening rates of the other room valves are proportionally set with respect to the maximum opening rate, for reduction, as the arrival time becomes shorter, to adjust the opening rates of the room valves depending on the ratio of the opening rates.

11. The method according to claim 3, including
reducing the opening rates of the respective room valves after measuring temperatures of returned heating water,
calculating a ratio of the opening rates of the respective room valves depending on a ratio of arrival times of the measured temperatures of the returned water to previously set temperatures, and
setting an opening rate of the room valve having the latest arrival time as a maximum opening rate such that the opening rates of the other room valves are proportionally set with respect to the maximum opening rate, for reduction, as the arrival time becomes shorter, to adjust the opening rates of the room valves depending on the ratio of the opening rates.

12. The method according to claim 4, including
reducing the opening rates of the respective room valves after measuring temperatures of returned heating water,
calculating a ratio of the opening rates of the respective room valves depending on a ratio of arrival times of the measured temperatures of the returned water to previously set temperatures, and
setting an opening rate of the room valve having the latest arrival time as a maximum opening rate such that the opening rates of the other room valves are proportionally set with respect to the maximum opening rate, for reduction, as the arrival time becomes shorter, to adjust the opening rates of the room valves depending on the ratio of the opening rates.
